(19) United States
(12) Patent Application Publication
(10) Pub. No.: US 2020/0094655 A1
(43) Pub. Date: Mar. 26, 2020

(54) AIR HEATING DEVICE

(71) Applicant: Webasto SE, Stockdorf (DE)

(72) Inventors: MARTIN ZOSKE, Stockdorf (DE); VOLODYMYR ILCHENKO, Stockdorf (DE); UWE STRECKER, Stockdorf (DE); BENGT MEIER, Stockdorf (DE); NIKOLAUS GERHARDT, Stockdorf (DE); MICHAEL SCHWANECKE, Stockdorf (DE)

(21) Appl. No.: 16/615,752

(22) PCT Filed: May 8, 2018
(86) PCT No.: PCT/EP2018/061803

§ 371 Date: Nov. 21, 2019

(30) Foreign Application Priority Data
May 24, 2017 (DE) 10 2017 111 373.8
May 24, 2017 (DE) 10 2017 111 378.9
Jul. 6, 2017 (DE) 10 2017 115 148.6
Sep. 12, 2017 (DE) 10 2017 121 039.3

(51) Int. Cl. B60H 1/22; F24H 3/04; F24H 1/10; F24H 1/12; F24H 1/20; H05B 3/14

(52) U.S. Cl. CPC B60H 1/2225; B60H 1/2218; F24H 3/04; F24H 1/103; F24H 2250/04; F24H 1/202; F24H 3/0429; H05B 3/146; F24H 1/121

(57) ABSTRACT

An electrical air heater, in particular for a motor vehicle, including a first heating element and at least one second heating element The heating elements each include a first conductive layer, in particular a first metal layer, a second conductive layer, in particular a second metal layer (11a, 11b), and a polymer layer. The polymer layer contains a polymer component and a conductive carbon component. An interspace is formed between the heating elements, through which interspace air is able to flow for the heating thereof.

### CROSS-REFERENCE TO RELATED APPLICATIONS

This application represents the national stage entry of PCT International Patent Application No. PCT/EP2018/061803 filed on May 8, 2018 and claims priority to German Patent Application No. DE 10 2017 111 378.9 filed May 24, 2017, German Patent Application No. DE 10 2017 111 373.8 filed May 24, 2017, German Patent Application No. DE 10 2017 115 148.6 filed Jul. 6, 2017, and German Patent Application No. DE 10 2017 121 039.3 filed Sep. 12, 2017. The contents of each of these applications are hereby incorporated by reference as if set forth in their entirety herein.

### DESCRIPTION

The disclosure relates to an air heater, in particular for a motor vehicle.

Electrical air heaters (in particular those used in mobile applications) are usually based on ceramic heating elements having a comparatively highly temperature-dependent electrical resistance, which enables self-regulation of the heat output. These resistors are usually PTC elements (PTC stands for Positive Temperature Coefficient). The latter are generally connected to heat transfer areas composed of sheet aluminium and are also electrically contacted via the latter. A PTC element comprises a PTC resistor, that is to say a temperature-dependent resistor having a positive temperature coefficient, which conducts the electric current better at low temperatures than at high temperatures.

Disadvantages of conventional air heaters having ceramic PTC elements are, inter alia, complex production as a result of comparatively complicated heat transfer manufacture and the incorporation of the ceramic elements, sorting of the ceramic elements that is usually necessary on account of manufacturing tolerances, a comparatively unfavourable power density in a heating element/heat transfer composite assembly as a result of local heat generation, a comparatively great limitation of a maximum heating power as a result of a thickness of the PTC material (on account of a limited heat dissipation from the ceramic), and a comparatively high risk of short circuit, in particular on account of a small geometric spacing of components having a high voltage potential.

It is an object of the disclosure to propose an air heater which enables air to be heated effectively. In particular, the intention is to enable a high power density in conjunction with a comparatively small structural space.

This object is achieved in particular by means of an electrical air heater according to claim 1.

In particular, the object is achieved by means of an electrical air heater, in particular for a motor vehicle, comprising a first heating element and at least one second heating element, wherein the heating elements each comprise a first conductive layer, in particular a first metal layer, a second conductive layer, in particular a second metal layer, and a polymer layer, wherein the polymer layer contains a polymer component and a conductive carbon component, wherein an interspace is formed between the heating elements, through which interspace air is able to flow for the heating thereof.

A central concept of the disclosure is to provide heating elements which each comprise two conductive layers (metal layers) and, arranged between the conductive layers (metal layers), a polymer layer comprising a polymer component and a conductive carbon component, wherein the heating elements form between them an (at least one) interspace (air flow channel), with the result that air can flow through said interspace (air flow channel or section of such an air flow channel) for the heating of said air.

According to the disclosure, it is possible to achieve a comparatively large contacting area between the conductive layers (supply lines, preferably metal plates) and the polymer layer (heating conductor layer), which enables a comparatively high power density (in comparison with conventional concepts, such as heating strips, in which contacting is usually achieved by way of two multi-stranded cables introduced into the heating conductor layer). Overall a high power density is achieved for an existing structural space as a result of a comparatively high contacting area between the conductive layers and the polymer layer. In this case, it is possible to achieve safety comparable with that in the case of conventional PTC heaters, by means of a self-regulating polymer layer (heating layer). Overall it is possible to achieve a robust design which is comparatively simple to produce.

Furthermore, the conductive layers (in particular metal layers, preferably metal plates) can simultaneously be used as a heat transfer area for heating the air flowing past. Optionally, this surface area can also be enlarged by unevennesses, in particular protrusions, such as ribs and/or fins, on the conductive layer (metal layer, in particular metal plate). For protection against mechanical damage, moisture and/or short circuits, lacquering and/or sealing of the individual heating element or at least of (exposed) regions of the heating layer(s) or of the entire component can be made possible. To summarize, a high power density (for a given structural space) can be realized as a result of a high contacting area between conduction elements (of the conductive layer) and the polymer layer (heating conductor layer). Here it is possible to produce safety comparable with that in the case of conventional PTC heaters having ceramic heating elements by means of a likewise self-regulating heating layer. In this case, the manufacturing costs are comparatively low by virtue of the possibility of using cost-effective materials and the possibility of simple production processes.

Heating elements having a partly similar layer construction have also been described in WO 2014/188190 A1, but for a surface heater rather than for an air heater in which the heating elements form between them one or more air channels (for the heating of same). However, there is a significant conceptional difference between air heaters and surface heaters, in particular on account of the multiplicity of air channels provided in the case of air heaters.

First and/or second heating element can extend (at least substantially) along an air flow direction. In the case of this alternative, heating elements having a comparatively large width (e.g. a width of at least 0.1 times or at least 0.2 times a length) can preferably be used. The width should be understood to mean, in particular, an (average) extent of the respective heating element which is perpendicular to a maximum extent (length), to be precise particularly in projection onto a plane defined by a connecting area between first conductive layer and polymer layer. Alternatively, first and/or second heating element can extend at an angle relative to the air flow direction (for example at an angle of less than or equal to 90° and greater than 0°, in particular greater than 10°). In the case of extending at an angle (of greater than 0°) relative to the air flow direction, comparatively narrow heating elements can preferably be used (that is to say heating elements whose width is comparatively small relative to their length, for example less than 0.2 times or less than 0.1 times their length).

The width of the respective heating element can extend in the flow direction. At least one of the heating elements (preferably a plurality or all of the heating elements) is (are) preferably shorter in the flow direction than in a direction perpendicular thereto, e.g. shorter by 50%.

A basic contour of the respective heating element (preferably of a plurality or all of the heating elements) can be polygonal, in particular quadrilateral, preferably rectangular, or oval, in particular elliptic, preferably round (circular).

At least one interspace (optionally a plurality or all of the interspaces) can be delimited by (exactly) two or more heating elements.

The polymer layer is preferably a conductive layer having PTC behaviour. A cross section of the interspace (air channel) can be polygonal, in particular quadrilateral, preferably rectangular, or oval, in particular elliptic, preferably round (circular). A cross section within an interspace (air channel) can vary or be constant (over the length thereof). Cross sections of different interspaces or air channels (that is to say interspaces or air channels which are not formed by the same pair or the same group of heating elements) can also deviate from one another or be identical. By way of example, cross sections of the interspaces or air channels can be embodied in slotted fashion (in particular as rectangular slots). The respective polymer layer (of at least one of the heating elements, preferably of a plurality or all of the heating elements) can be (at least on average) thicker than the first and/or second conductive layer (metal layer) (for example at least 1.1 times, preferably at least 1.5 times, as thick as first and/or second conductive layer (metal layer)). Alternatively, the respective first and/or second conductive layer (metal layer) can be thicker than the polymer layer. First and second conductive layers (metal layers) can be (at least on average) of identical thickness.

Optionally, the first conductive layer (metal layer) of at least one heating element (preferably of a plurality or all of the heating elements) can also be thicker than the respective second conductive layer (metal layer) (or vice versa), for example 1.0 times to 2.0 times as thick. A maximum extent of first and/or second conductive layer (metal layer) and/or polymer layer of at least one heating element, preferably of a plurality or all of the heating elements (preferably defined by the maximum possible spacing of a pair of points on/in the respective layer), is preferably at least 5 times, more preferably at least 10 times, the magnitude of an (average) thickness of the respective layer. The respective first and/or second conductive layer (metal layer) of at least one heating element (preferably of a plurality or all of the heating elements) can be embodied as a conductive plate (metal plate).

The respective first and/or second conductive layer of at least one heating element (preferably of a plurality or all of the heating elements) can be (one) continuous layer. Alternatively, the first and/or second conductive layer can be interrupted, e.g. have a plurality of (sheet metal) strips for contacting the polymer layer. A further alternative for electrical contacting (in the form of the conductive layer) is the use of at least one wire or narrow strip or a wire grid or the like as conductive layer or part thereof.

The term “conductive” with regard to the conductive carbon component and the conductive layer should be understood as an abbreviation of “electrically conductive”.

An electrically insulating material should be understood to mean, in particular, a material which has an electrical conductivity of less than 10⁻¹ S·m⁻¹ (optionally less than 10⁻⁸ S·m⁻¹) (at room temperature of, in particular, 25° C.). Accordingly, an electrical conductor or a material (or coating) having electrical conductivity should be understood to mean a material having an electrical conductivity of preferably at least 10 S·m⁻¹, more preferably at least 10³ S·m⁻¹ (at room temperature of, in particular, 25° C.).

The (respective) first and/or second conductive layer (metal layer) of at least one heating element (preferably of a plurality or all of the heating elements) can have a thickness of at least 0.1 mm, preferably at least 0.5 mm, more preferably at least 1.0 mm and/or at most 5.0 mm, more preferably at most 3.0 mm. The respective thickness is, in particular, an average thickness or a thickness of the largest region of the respective layer with constant thickness.

The (respective) polymer layer of at least one heating element (preferably of a plurality or all of the heating elements) can have a thickness which is greater than the (average) thickness of the first and/or second conductive layer (metal layer), in particular greater by a factor of 1.1 times, preferably 1.5 times.

A thickness of the respective polymer layer of at least one heating element (preferably of a plurality or all of the heating elements) can be at least 1 mm, preferably at least 3 mm and/or at most 20 mm, preferably at most 10 mm.

The (respective) first and/or second conductive layer (metal layer) and/or polymer layer of at least one heating element (preferably of a plurality or all of the heating elements) can be embodied in (at least substantially) planar fashion. If elevations (recesses) are provided, they can amount to less than 10% of an (average) thickness of the respective layer.

A sum of the cross sections of the interspaces (or of the one interspace) between the heating elements can be at least 2 times, preferably at least 4 times, the magnitude of a sum of the cross sections of the heating elements (in particular as viewed transversely with respect to the air flow direction or transversely with respect to the width direction).

The (respective) first and/or second conductive layer (metal layer) of at least one heating element (preferably of a plurality or all of the heating elements) can be manufactured from aluminium or an aluminium alloy.

The (respective) carbon component of at least one heating element (preferably of a plurality or all of the heating elements) can be arranged such that it allows a current flow, e.g. in particle form (with the particles correspondingly touching one another or being close together) and/or as a carbon backbone.

Polymer component and carbon component of at least one heating element (preferably of a plurality or all of the heating elements) are preferably mixed together or interlaced in one another. By way of example, the polymer component can form a (skeletonlike) backbone in which the carbon component is received, or vice versa.

Preferably, the (respective) polymer layer comprises at least 5% by weight, preferably at least 10% by weight, even more preferably at least 15% by weight, even more preferably at least 20% by weight and/or less than 50% of carbon (if appropriate without taking into account a carbon fraction of the polymer as such) or of the carbon component, such as e.g. the carbon particles.

Preferably, the (respective) carbon component comprises at least 70% by weight of carbon.

The carbon component of at least one heating element (in particular of a plurality or all of the heating elements) can be present in the form of carbon black and/or graphite and/or graphene and/or carbon fibres and/or carbon nanotubes.

Preferably, the carbon component of at least one heating element (preferably of a plurality or all of the heating elements) comprises at least 50% by weight, more preferably at least 80% by weight, even more preferably at least 90% by weight of carbon.

The polymer component of at least one heating element (preferably of a plurality or all of the heating elements) is embodied in particular in the form of an electrically insulating polymer component.

In embodiments, the polymer component of at least one heating element (preferably of a plurality or all of the heating elements) can comprise a first polymer subcomponent based on ethylene acetate (copolymer) and/or ethylene acrylate (copolymer) and/or a second polymer subcomponent based on polyolefin, in particular polyethylene and/or polypropylene, and/or polyester and/or polyamide and/or fluoropolymer. The term “subcomponent” is intended to be used here in particular for differentiation between first and second polymer subcomponents. The respective subcomponent can form the polymer component either in part or else in full. The ethylene acrylate can be ethyl methyl acrylate or ethylene ethyl acrylate. The ethylene acetate can be ethylene vinyl acetate. The polyethylene can be HD (High Density) polyethylene, MD (Medium Density) polyethylene, LD (Low Density) polyethylene. The fluoropolymer can be PFA (copolymer composed of tetrafluoroethylene and perfluoropropyl vinyl ester), MFA (copolymer composed of tetrafluoroethylene and perfluorovinyl ester), FEP (copolymer composed of tetrafluoroethylene and hexafluoropropylene), ETFE (copolymer composed of ethylene and tetrafluoroethylene) or PVDF (polyvinylidene fluoride).

In embodiments, the first polymer subcomponent of at least one heating element (preferably of a plurality or all of the heating elements) can be embodied as described in WO 2014/188190 A1 (as first electrically insulating material). The second polymer subcomponent can likewise be embodied as described in WO 2014/188190 A1 (as second electrically insulating material).

The (respective) polymer layer and/or a corresponding substance (e.g. paste) to be shaped for its production can comprise (as, in particular, crystalline binder) at least one polymer, preferably based on at least one olefin; and/or at least one copolymer of at least one olefin and at least one monomer which can be copolymerized therewith, e.g. ethylene/acrylic acid and/or ethylene/ethyl acrylate and/or ethylene/vinyl acetate; and/or at least one polyalkenamer (polyacetylene or polyalkenylene), such as e.g. polyoctenamer; and/or at least one, in particular melt-deformable, fluoropolymer, such as e.g. polyvinylidene fluoride and/or copolymers thereof.

In general, the (respective) polymer layer or a substance (paste) used for producing the polymer layer can be embodied as described in DE 689 23 455 T2. This also holds true, in particular, for the production and/or concrete composition thereof. By way of example, this also holds true for possible binders (in particular in accordance with page 4, 2nd paragraph and page 5, 1st paragraph of DE 689 23 455 T2) and/or solvents (in particular in accordance with page 5, 2nd paragraph and page 6 2nd paragraph of DE 689 23 455 T2).

First and/or second conductive layer (metal layer) and/or the polymer layer of at least one heating element (preferably of a plurality or all of the heating elements) can be embodied in principle as described in WO 2014/188190 A1 (as first conductor, second conductor and heating element) (apart from the air channels according to the disclosure).

The polymer layer of at least one heating element (preferably of a plurality or all of the heating elements) is in contact with the first conductive layer (metal layer) preferably over at least 20%, preferably at least 50%, more preferably at least 80%, of its side facing the first conductive layer (metal layer) (without taking into account fluid channel openings). Alternatively or additionally, the polymer layer can be in contact with the second conductive layer (metal layer) over at least 20%, preferably at least 50%, more preferably at least 80%, of its side facing the second conductive layer (metal layer) (without taking into account fluid channel openings). Such a (comparatively large) contacting area between the conductive layers (metal layers) (metal plates) and the heating conductor layer (polymer layer) makes it possible to achieve a comparatively high power density.

The polymer layer of at least one heating element (preferably of a plurality or all of the heating elements) is preferably a PTC resistor. As a result, self-regulation of the heat output can be made possible, which simplifies the control and in particular increases safety during operation.

The object mentioned above is furthermore achieved by means of a method for producing an air heater, in particular of the above type, wherein at least one first and one second heating element are provided or produced, wherein the heating elements each comprise a first conductive layer, in particular a first metal layer, a second conductive layer, in particular a second metal layer, a polymer layer, wherein the polymer layer contains a polymer component and a conductive carbon component, wherein the heating elements are arranged such that they form an interspace between them, through which interspace air can flow for the heating thereof. Preferably, the polymer layer of at least one heating element (preferably of a plurality or all of the heating elements) is applied in an appropriate form on the first and/or second conductive layer (metal layer), in particular applied directly (alternatively by way of an intermediate layer between polymer layer and first and/or respectively second conductive layer, in particular metal layer).

In embodiments, at least three, preferably at least five, heating elements with corresponding (e.g. at least four) interspaces can be provided.

A diameter of the interspace between the first and second heating elements can be greater than a thickness of the first and/or second heating element.

At least one protrusion, preferably at least one rib and/or at least one fin, can be provided (for the purpose of enlarging the heat transfer area) on the respective conductive layer of at least one heating element (preferably of a plurality or all of the heating elements).

The object mentioned above is furthermore achieved by means of a method for operating an air heater of the above type, wherein air flows through the at least one interspace and is heated in the process.

The above object is furthermore achieved by means of a use of an air heater of the type described above for heating air, in particular in a motor vehicle, preferably for a motor vehicle interior.

The air heater is preferably designed for operation in the low-voltage range (e.g. 100 volts or 50 volts).

Further embodiments are evident from the dependent claims.

The disclosure is described below on the basis of exemplary embodiments which are explained in greater detail with reference to the accompanying figures, in which:

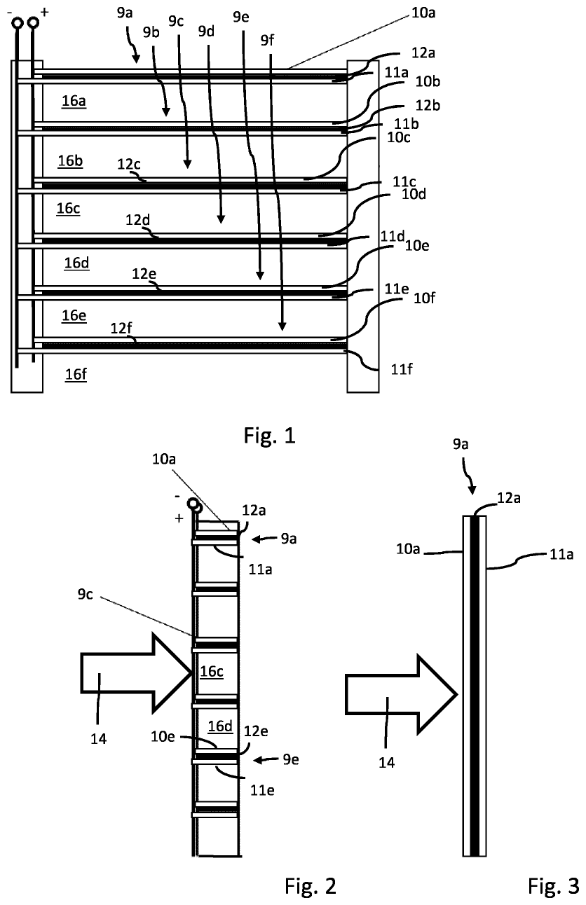

FIG. 1 shows a schematic frontal view of an electrical air heater according to the disclosure;

FIG. 2 shows a schematic side view of the embodiment in accordance with FIG. 1 in a sectional illustration; and

FIG. 3 shows a schematic side view of an alternative embodiment of an electrical air heater according to the disclosure in a sectional illustration analogous to FIG. 2.

In the following description, the same reference signs are used for identical and identically acting parts.

FIG. 1 shows a frontal view of an air heater according to the disclosure. Said air heater comprises a plurality of heating elements 9a-9f (specifically six, although this is not mandatory). Each of the heating elements 9a comprises a first conductive layer 10a-10f, a second conductive layer 11a-11f and a polymer layer 12a-12f. The respective first and second conductive layers are connected to electrical contacts 15a, 15b. Interspaces (fluid channels) 16a-16e are formed between the heating elements 9a-9f. The air flows through said interspaces 16a-16e for the heating of said air (in FIG. 1 into the plane of the drawing or out of the plane of the drawing). A further interspace 16f can optionally be provided outside a (marginal) heating element (heating element 9f in this case).

In the sectional illustration in accordance with FIG. 2, in particular the air flow is also indicated by an arrow 14.

The respective conductive layer is, in particular, a metal layer (preferably composed of aluminium or an aluminium alloy). The respective polymer layer is a layer based on polymer comprising a carbon fraction. The polymer layer has a PTC behaviour.

The alternative embodiment in accordance with FIG. 3 differs from the embodiment in accordance with FIG. 1 in that the heating elements here do not extend along the air flow direction (see FIG. 2), but rather perpendicularly thereto, such that only one heating element 9a is discernible in the illustration in accordance with FIG. 3 since the other heating elements are concealed by this heating element. Here, too, once again six heating elements can be present, for example. The interspaces are likewise concealed by the heating element 9a.

It should be pointed out at this juncture that all parts described above, considered by themselves and in any combination, in particular the details illustrated in the drawings, are claimed as essential to the disclosure. Modifications thereof are familiar to the person skilled in the art.

### LIST OF REFERENCE SIGNS

9a-9f Heating element
10a-10f First conductive layer (metal layer)
11a-11f Second conductive layer (metal layer)
12a-12f Polymer layer
Arrow
15a, 15b Contact
16a-16f Interspace (fluid channel)

1. Electrical air heater for a motor vehicle, comprising a first heating element and at least one second heating element, wherein the heating elements each comprise a first conductive layer, a second conductive layer, and a polymer layer, wherein the polymer layer contains a polymer component and a conductive carbon component,
wherein an interspace is formed between the heating elements, through which interspace air is able to flow for the heating thereof.

2. Air heater according to claim 1,
wherein
first and/or second heating element extend(s) at least substantially along an air flow direction and/or extend(s) at an angle relative to the air flow direction.

3. Air heater according to claim 1,
wherein
the respective first and/or second conductive layer are/is embodied as a plate.

4. Air heater according to claim 1,
wherein
the respective first and/or second conductive layer and/or the polymer layer are/is embodied in at least substantially planar fashion.

5. Air heater according to claim 1,
wherein
at least three heating elements with corresponding interspaces are provided.

6. Air heater according to claim 1,
wherein
a diameter of the interspace between the first and the second heating element is greater than a thickness of the first and/or second heating element.

7. Air heater according to claim 1,
wherein
at least one protrusion is provided on the respective conductive layer, for the purpose of enlarging the heat transfer area.

8. Air heater according to claim 1,
wherein
the carbon component is present in particle form and/or as a carbon backbone.

9. Air heater according to claim 1,
wherein
the carbon component is present in the form of carbon black and/or graphite and/or graphene and/or carbon fibres and/or carbon nanotubes.

10. Air heater according to claim 1,
wherein
the polymer component is embodied in the form of an electrically insulating polymer component and/or comprises a first polymer subcomponent based on ethylene acetate or ethylene acetate copolymer and/or ethylene acrylate or ethylene acrylate copolymer and/or a
second polymer subcomponent based on polyolefin and/or polyester and/or polyamide and/or fluoropolymer.

11. Air heater according to claim 1,
wherein
the polymer layer is in contact with the first conductive layer over at least 20% of its side facing the first conductive layer and/or
is in contact with the second conductive layer over at least 20% of its side facing the second conductive layer.

12. Air heater according to claim 1,
wherein
the polymer layer is a PTC resistor.

13. Method for operating an air heater according to claim 1, wherein air flows through the at least one interspace and is heated in the process.

14. A motor vehicle comprising an air heater according to claim 1 for heating air in an interior of the motor vehicle.

15. Electrical air heater of claim 1, wherein the first conductive layer is a metal layer and the second conductive layer is a metal layer.

16. Air heater according to claim 2, wherein the heating element extend(s) at an angle relative to the air flow direction at an angle of less than or equal to 90° and greater than 0°. in particular greater than 10°.

17. Air heater according to claim 2, wherein the heating element extend(s) at an angle relative to the air flow direction at an angle of less than or equal to 90° and greater than 10°.

18. Air heater according to claim 1 wherein the respective first and/or second conductive layer are/is embodied as a metal plate and/or have/has a thickness of at least 0.1 mm and/or at most 5.0 mm.

19. Air heater according to claim 1, wherein the protrusion is at least one rib and/or at least one fin.

20. Air heater according to any of the preceding claims claim 10, wherein the second polymer subcomponent is based on polyethylene and/or polypropylene.
